(19) United States
(12) Patent Application Publication
(10) Pub. No.: US 2002/0083642 A1
(43) Pub. Date: Jul. 4, 2002

(54) Container with decoration and utility and the method of manufacture thereof

(76) Inventor: Chim Pak Kee Simon, Kowloon (HK)

Correspondence Address: BACON & THOMAS, PLLC, 4th Floor, 625 Slaters Lane, Alexandria, VA, 22314-1176, US

(21) Appl. No.: 09/808,050

(22) Filed: Mar. 15, 2001

(30) Foreign Application Priority Data
Jan. 4, 2001 (TW) 90100191

(51) Int. Cl. A01G 9/02

(52) U.S. Cl. 47/72

(57) ABSTRACT

This present invention relates to a container with decoration and utility and the method of manufacture thereof, especially to containers with decoration and utility made in the constant temperature by covering vases having apertures with certain wrapping material (namely polymer resin such as low solvent resin or acrylic plastic,) wherein the original vase apertures can remain uncovered and no gap is formed at the seam between the wrapping material and the aperture.

### FIELD OF THE INVENTION

This present invention relates to a container with decoration and utility and the method of manufacture thereof; especially to containers with decoration and utility made in the constant temperature by covering vases having apertures with certain wrapping material, wherein the original vase apertures can remain uncovered and no gap is formed at the seam between the wrapping material and the aperture.

### DESCRIPTION OF THE PRIOR ART

With improved quality of living, people increasingly expect more from the living space design and multi-functional decorative objects. Decorative objects are no longer designed simply with the traditional notion of appeasing to the visual aesthetic taste, but instead aimed to incorporate both aesthetic and practical aspects into the design.

Currently the market offers many types of decorative objects for display made by wrapping transparent resin over objects, such as glass containers, plastic objects, metal objects, etc., to form transparent decorative objects of specific shapes. However, in the conventional method, objects are completely wrapped inside the resin and totally sealed therein so that any apertures of the objects (such as the opening of a glass bottle or cup) would be covered and rendered useless. On the other hand, in the traditional technology, if the resin and the objects covered by it are of different materials (e.g., glass,) during the solidification of cooling from high to low temperature, cracks or blemish spots tend to form in the final solidified resin and thereby mar the decorative value.

The primary object of the present invention is about providing a container with decoration and utility, comprising primarily: a vase with aperture and the wrapping material, said wrapping material wraps over the entire vase except its aperture; said wrapping material is polymer resin such as low solvent resin or acrylic plastic, and said wrapping material is leveled at the height of the vase aperture.

An alternative object of the present invention is providing a manufacturing method wherein vases having apertures are wrapped in the wrapping material in the constant temperature to make them into containers with decoration and utility while retaining their original functions as vases. In this manufacturing method, no gap is formed at the seam between the resin of the container and the aperture of the vase. The wrapping material is polymer resin such as low solvent resin or acrylic plastic (low solvent resin is the preferred choice).

The container with decoration and utility and the method of manufacture thereof presented in the present invention not only improves upon the drawbacks of the conventional art, but also overcomes the limitations associated with the traditional resin decorative objects and offers decorative containers which can be used for decorative display while having practical usage.

### BRIEF DESCPTION OF THE DRAWINGS

The many strengths and characteristics of the present invention may be further elaborated by the use of following figure:

FIG. 1. A flowchart of the method of manufacturing the container with decoration and utility of the present invention.

FIG. 2. (A) Illustration of the vase that is to be wrapped hanging over the mold during the manufacture process;

(B) Illustration of filling the inside of the mold with the wrapping material during the manufacture process;

(C) Illustration of the container of the present invention after the application of the surface treatment;

(D) Sectional view of the container of the present invention.

FIG. 3. A 3D view of an instance of embodiment of the container with decoration and utility of the present invention.

### SUMMARY OF INVENTION

The present invention aims to overcome the drawbacks associated with the conventional technique of wrapping resin over objects and offers a container with decoration and utility and the manufacturing method thereof. Said container comprises primarily: a vase with aperture and the wrapping material, said wrapping material wraps over the entire vase except its aperture, said wrapping material is polymer resin such as low solvent resin or acrylic plastic, and said wrapping material is leveled at the height of the vase aperture.

In the manufacturing method disclosed hereof, the vase is completely wrapped inside the wrapping material in a constant temperature environment; after the wrapping material is solidified and cooled, surface treatment is applied and the portion of wrapping material above the aperture of the vase is removed by grinding it away to preserve the original aperture. No gap is formed in the seam between the aperture and the wrapping material and the drawbacks of cracking and blemish spots associated with the conventional method are eliminated. The final product is a container with decoration and utility. Said wrapping material is polymer resin such as low solvent resin or acrylic plastic (low solvent resin is the preferred choice).

### DETAILED DESCRIPTION OF THE INVENTION

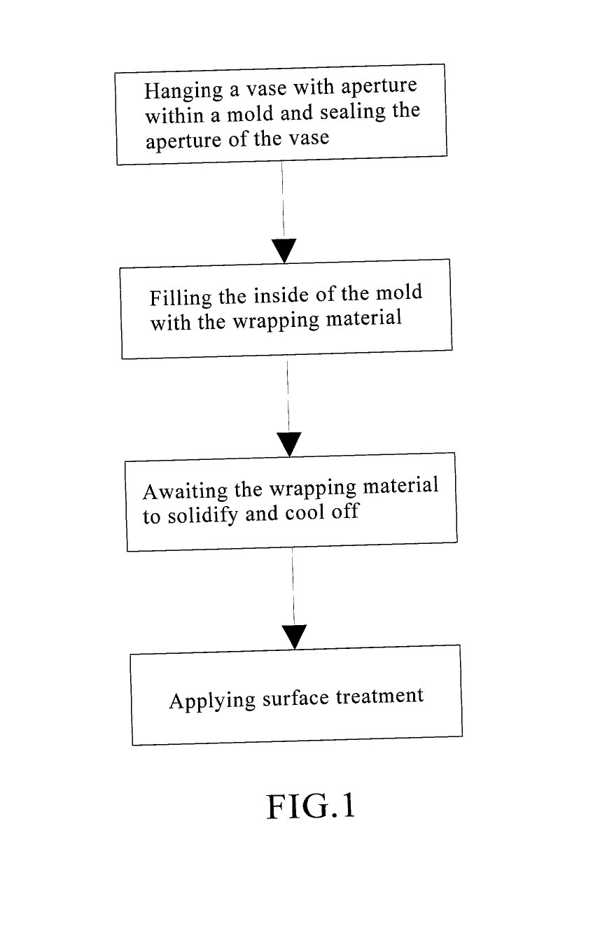

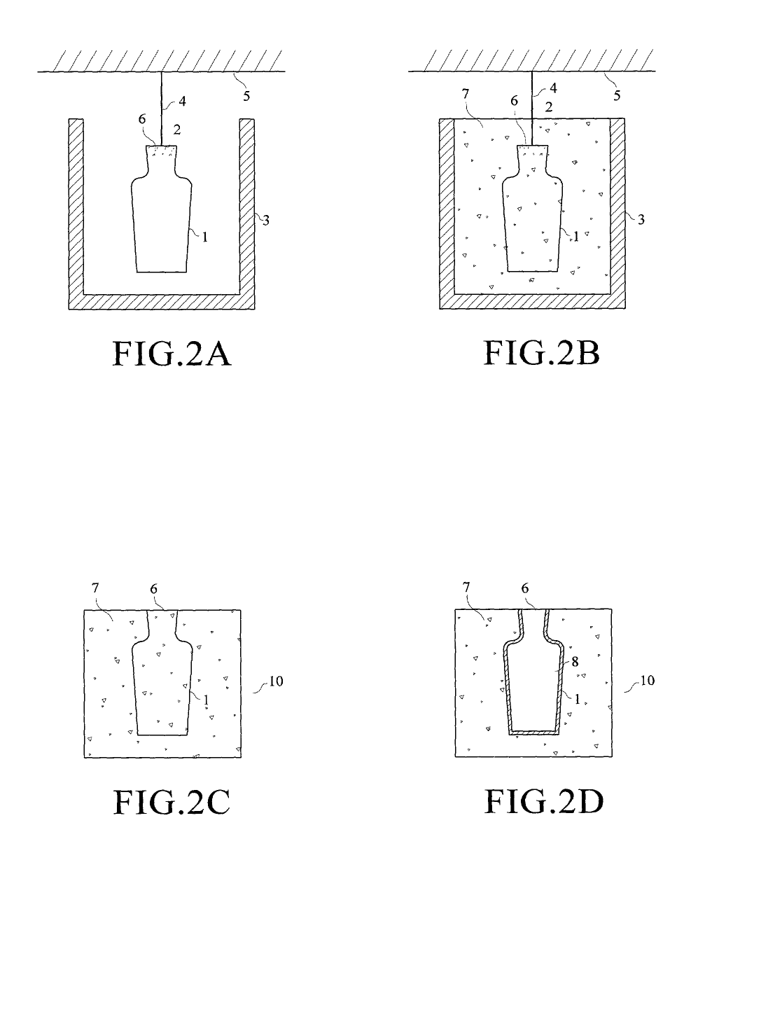

The present invention provides a container with decoration and utility and the manufacturing method thereof. The manufacturing method is illustrated in FIG. 1. First, the vase to be wrapped inside the wrapping material (e.g., bottle, cup, basin, etc.,) is hung within a mold of specific shape as shown in FIG. 2(A). A hanging device 4 hangs the vase 1 at the fixed point 5 and sealing device 2 seals the aperture 6 of said vase 1 to prevent seepage of the wrapping material into the vase 1. Thereafter said hung vase 1 is placed within a mold of specific shape 3 and poured inside said mold 3 is the wrapping material 7 that completely covers the vase 1 within as shown in FIG. 2(B). Said wrapping material is polymer resin such as low solvent resin (such as polystyrene) or acrylic plastic. Said mold can be cast in various desirable shapes. After the wrapping material 7 is filled, as shown in the flowchart of FIG. 1, and after it becomes solidified and cooled, said mold 3 is removed and surface treatment is applied to the solidified wrapping material 7. In said surface treatment, portion of wrapping material 7 over and above the aperture 6 of the vase 1 is removed by the usual grinding method, so that the wrapping material 7 is leveled off at the height of the aperture 6, thereafter the sealing device 2 is removed to reveal the aperture 6 of the vase 1 as shown in FIG. 2(C). FIG. 2(D) is the sectional view of the container 10 of the present invention. It shows therein that the container retains the aperture 6 and the interior space 8 of the vase 1 and thereby retains its utility. An alternative object of said surface treatment is to make the surface of the wrapping body smooth and luminous.

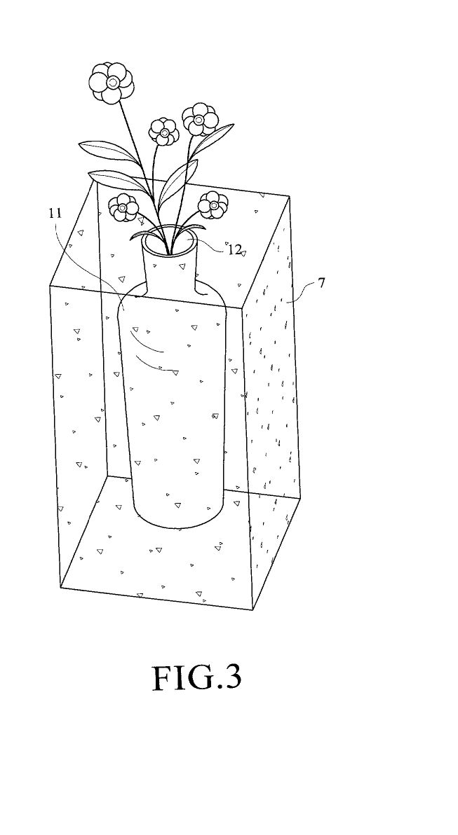

FIG. 3 shows that the container with decoration and utility is obtained by wrapping a bottle 11 inside the wrapping material 7. The manufacturing method of the present invention allows the bottle 11 to retain its opening 12 and the interior space, so that the container 10 not only retains the utility of the bottle (e.g., flower vase) but can also serve as a decorative object.

The manufacturing method of the present invention is characterized by the wrapping material of polymer resin such as low solvent resin or acrylic plastic (low solvent resin is preferred choice) as filling the inside of the mold. The object is to minimize the effect due to different contraction ratio as between the different materials comprising the wrapping material and the vase during the solidification of the wrapping material, so as to prevent formation of cracks or blemish spots in the subsequent solidified wrapping material. Further the primary characteristic of the manufacturing method of the present invention is the retaining of the original aperture of the vase to preserve its utility, and that no gap is formed in the seam between the wrapping material and the aperture. To achieve this aim, the vase to be wrapped is first completely covered within the wrapping material, and before the immersion the aperture of the vase is sealed to prevent seeping in of the wrapping material. After the wrapping material is cooled and solidified, portion thereof above the aperture of the vase is ground away so that the wrapping material is leveled at height with the aperture of the vase. This method improves over the conventional method in which the vase is exposed to air so that gap is formed between the vase and the wrapping material because of the difference in the cooling contraction ratio between the two different materials. Further, the surface treatment of the present invention makes the final decorative object smooth and luminous.

Another difference between the conventional manufacturing method and the manufacturing method of the present invention is that in the present invention the entire process is performed in a constant temperature environment (e.g., 27˜30° C.). Because said wrapping material can remain chemically stable under constant temperature, it less likely undergoes chemical changes during the manufacturing process (such as formation of blemish spots or patterns, etc.,) and the visually smooth and luminous final product can be obtained.

During the manufacturing process of the present invention, color additives can be added into the wrapping material for desired colors to obtain containers with decoration and utility wrapped in wrapping material of various colors.

In conclusion, the present invention of a container with decoration and utility and the manufacturing method thereof improves upon the conventional method and produces containers with both utility and decoration.

After a detailed description of the present invention of a container with decoration and utility, those skilled in this field of art can fully grasp the invention and make various modifications without departing from the spirit and the scope of the claims.

### EFFECTIVENESS OF THE INVENTION

The present invention relates to a container with decoration and utility and the method of manufacture thereof, its characteristic is using wrapping material (polymer resin such as low solvent resin or acrylic plastic) to wrap over vases with apertures to produce containers with decoration and utility, because the apertures of the original vases can be retained, the containers have both decoration and utility values. The present invention possesses many fine features, and provides solutions to the drawbacks of the conventional method.

What is claimed is:

1. A container with decoration and utility, comprising: a vase with aperture and wrapping material; said wrapping material wraps over entire said vase except its aperture.

2. A container with decoration and utility as recited in claim 1, wherein said wrapping material is polymer resin such as low solvent resin or acrylic plastic.

3. A container with decoration and utility as recited in claim 2, wherein said low solvent resin is polystyrene.

4. A container with decoration and utility as recited in claim 1, wherein said wrapping material is leveled off at the height of the aperture.

5. A container with decoration and utility as recited in claim 1, wherein said vase with aperture is a container such as a bottle, cup or basin.

6. A container with decoration and utility as recited in claim 1, wherein color additives may be added into the wrapping material to produce containers with decoration and utility in various colors.

7. A method for manufacturing a container with decoration and utility, comprising the following steps:
1. hanging a vase with aperture within a mold;
2. filling the inside of said mold with said wrapping material, wherein said wrapping material must completely wrap over the entire vase;
3. awaiting said wrapping material to solidify and cool off;
4. applying surface treatment and grinding off that portion of said wrapping material above the aperture of the vase to reveal the aperture.

8. A method for manufacturing a container with decoration and utility as recited in claim 7, wherein said vase with aperture is a container such as a bottle, cup or basin.

9. A method for manufacturing a container with decoration and utility as recited in claim 7, wherein said mold can be cast in various shapes.

10. A method for manufacturing a container with decoration and utility as recited in claim 7, wherein said wrapping material is polymer resin such as low solvent resin or acrylic plastic.

11. A method for manufacturing a container with decoration and utility as recited in claim 10, wherein said low solvent resin is polystyrene.

12. A method for manufacturing a container with decoration and utility as recited in claim 7, wherein prior to administering said step 2, sealing the aperture of said vase with a sealing device to prevent seepage of the wrapping material into the vase.

13. A method for manufacturing a container with decoration and utility as recited in claim 7, wherein no gap is formed in the seam between said wrapping material and said aperture of the vase.

14. A method for manufacturing a container with decoration and utility as recited in claim 7, wherein said method is carried out in a constant temperature environment.

15. A method for manufacturing a container with decoration and utility as recited in claim 7, wherein temperature of said constant temperature environment is controlled at between 27˜30° C.

16. A method for manufacturing a container with decoration and utility as recited in claim 7, in said step 2 thereof adding color additives into said wrapping material to produce containers with decoration and utility in various colors.
